(19) United States
(12) Patent Application Publication
(10) Pub. No.: US 2024/0269899 A1
(43) Pub. Date: Aug. 15, 2024

(54) COMPUTER-ASSISTED METHOD FOR DESIGNING ELASTOMERIC SKIN FOR ROBOTS AND ROBOTIC DEVICES

(71) Applicant: DISNEY ENTERPRISES, INC., BURBANK, CA (US)

(72) Inventors: Moritz Niklaus Bächer, Zürich (CH); Daniele Panozzo, New York City, NY (US); Denis Zorin, New York City, NY (US); Arvi Gjoka, New York City, NY (US); Lars Espen Knoop, Birmensdorf (CH); Christian Gabriel Schumacher, Aarau (CH)

(21) Appl. No.: 18/110,278

(22) Filed: Feb. 15, 2023

(51) Int. Cl. B29C 33/38; B29C 39/02; G06F 30/12; G06F 30/20

(52) U.S. Cl. CPC B29C 33/3835; B29C 39/025; G06F 30/12; G06F 30/20; G06F 2113/22

(57) ABSTRACT

A computer-assisted method (and a computer system implementing a design tool and skin fabricated according to these designs) for designing elastomeric skin for robots and robotic devices. The skin design tool is configured to facilitate the optimal navigation of the design space spanned by an animatronic or robotic device skin. The skin design tool includes a soft body simulator that is differentiable with respect to control and design parameters, which enables the skin design tool to provide one or more of the following applications: (1) automated identification of an optimal neutral pose for the skin that minimizes peak stresses when the skin is brought into extreme poses; (2) automated optimization of the skin thickness and shape of a skin to meet a time-varying artistic target; and (3) automated optimization of a skin to achieve a desired behavior if the skin is allowed to slide along an underlying rigid shell.

### BACKGROUND

### 1. Field of the Description

The present description relates, in general, to design of artificial skin or skin systems for use with robots and robotic devices such as animatronic (or robotic) heads, and, more particularly, to a system (and associated methods and skin products made according to designs output by such methods) for providing computational-based assistance to a robot or animatronic skin designer to design an elastomeric (or artificial) skin (e.g., a head covering) that in use can achieve targeted skin movements that meet both artistic and mechanical demands.

### 2. Relevant Background

There are many applications for skins or skin systems that are used to create realistic models of humans, animals, and characters, and, when these skins are combined with robotics (which may also be known as animatronics), a device can be provided that can accurately simulate live beings with similar expressive skin movements. These skins are typically formed of durable materials that are often also flexible and elastic (e.g., elastomers) such as plastic and rubbers so that they can readily move and stretch with underlying robotics (e.g., actuators, drivers, and the like).

Robotics can involve the design and use of robots to provide programmable actuators or drivers to perform tasks, and, more recently, there have been significant demands for robotic devices that simulate humans, animals, and other living beings or characters. These robotic characters are relied upon heavily in the entertainment industry to provide special effects for movies and television and to provide robots that simulate live beings for shows and displays in amusement or theme parks. For example, robotics or animatronics may be used to provide a character in a theme park ride or show that repeats a particular set of movements or actions (e.g., programmed tasks) based on the presence of park visitors or a ride vehicle or another triggering event.

In simulating human or human-like characters, the robots are typically covered in a skin that is fabricated of flexible (or elastomeric) material to move naturally with the underlying and actuating robotics. The skin may be formed of a rubber material or a silicone that is attached or anchored to the mechanical actuators or drivers of the robotic system, and the skin is configured to have an outward appearance similar to the character or creature being simulated by the robot. For example, facial skins can be formed so as to have an uncanny resemblance to the character or person they are imitating, but this resemblance may end when the attached robotics begin animating the face. The connection or anchoring points can become apparent as the skin is pulled or pushed from behind (or underneath) by the robotic components upon which the skin is mounted.

To date, skin systems have typically been designed and fabricated through time-consuming manual processes that often relied heavily on the skill of the artisans involved in the process. The manual design of an animatronic head combining actuators, supports, and an overlying skin has provided challenging as the design has to meet both artistic and mechanical targets. The design challenge is in large part due to the skin that, during use or actuation by a mechanical assembly, undergoes very large deformations. To meet an artistic target, it is desirable to have a skin that can be deformed into various target expressions. To meet mechanical requirements, local deformations have to be kept within bounds because the skin will not last when undergoing repetitive use if stresses exceed strength limits of the material.

Optimally navigating this tradeoff between artistic and mechanical design demands without the help of computing devices and algorithms has proven difficult. Hence, there is a need for a computer-assisted method for designing animatronic skin for a robotic device or robot that will allow the designer to get to the limits of how realistic and full of expression a skin and robot combination can appear to an observer.

### SUMMARY

To address the above and other issues with skin design for animatronics and other mechanical assemblies, a computer-assisted method is provided for optimizing design of an elastomeric skin for covering a mechanical assembly. The method includes, with a computing device, receiving or accessing in memory user input including a definition of the mechanical assembly design and control parameters for the mechanical assembly. Also, with the computing device, the method includes receiving or accessing in memory a set of design parameters for a skin or skin system, for at least partially covering the mechanical assembly, including material used to fabricate a body of the skin, an initial shape of the body of the skin, and an initial thickness of the body of the skin. Then, the method continues, with the computing device, receiving or accessing in memory a target shape of an outer surface of the body of the skin at a predefined time of operations of the mechanical assembly.

Significantly, the method also includes, with a skin design program running on the computing device, generating an optimized design for the skin system by generating an optimized shape of the body and an optimized thickness of the body based on the initial shape and the initial thickness. The optimized shape and the optimized thickness are selected or computed by the skin design program such that the outer surface of the body of the skin substantially matches the target shape at the predefined time during the operations of the mechanical assembly.

In some preferred embodiments, the user input further comprises a definition of a set of Elastomeric Actuation Pieces (EAPs) (also called “Points” instead of “Pieces” by some in the relevant arts) for attaching the skin body to the mechanical assembly. The definition includes a definition of body shapes and materials for the EAPs along with a location for mounting each of the EAPs on the mechanical assembly. The EAPs, in fabricating a robot or animatronic/robotic device, are attached on a first side to the mechanical assembly and have a second side with a recessed surface for receiving a portion of an EAP post extending outward from an inner surface of the skin body, whereby the EAPs are not integrally bound to the skin body. In some preferred implementations, the EAPs are formed of a material with a hardness greater than a hardness of the material used to form the body of the skin. In these or other implementations, the generating of the optimized design further includes optimizing time-varying positions of one or more of the EAPs. It may also be desirable for the generating of the optimized design to further include generating a neutral pose for the skin body.

The skin design program may include a soft body simulator configured to simulate movement of the body of the skin during operations of the mechanical assembly. In such implementations, the soft body simulator can be configured to process frictional contact between soft bodies and between rigid and soft bodies via a contact model that is differentiable. Further, the soft body simulator can be configured to predict dynamic behavior of the skin system during operations of the mechanical assembly. Additionally, it often will be desirable for the soft body simulator to be configured to be differentiable with respect to the shape and the thickness of the body of the skin in an unstressed, neutral pose. Still further, the method may be implemented with the soft body simulator being configured to be differentiable with respect to motion of either the EAPs or the control parameters of motors of the mechanical assembly operable to drive motion of the mechanical assembly.

Once generated by the computer-assisted design method, the optimized skin system design may be used to product a robot or animatronic/robotic device that is fabricated to include a physical implementation of the mechanical assembly covered by a skin or skin system fabricated based on the definition of the optimized design for the skin system. This would include attaching EAPs to the mechanical assembly (e.g., surfaces of a shell and driver/actuator components) and then attaching the skin or skin system via its EAP mounting posts to the EAPs, with the EAPs not being integrally bound to the surrounding skin as was the case with some prior skin designs.

### BRIEF DESCRIPTION OF THE DRAWINGS

FIG. 1 illustrates, with a schematic or representative side view, a skin-covered apparatus or object with a robotics assembly covered by a skin or skin system designed according to the design method of the present description;

FIG. 2 illustrates the skin-covered apparatus or object of FIG. 1 showing parameters or features of the skin or skin system that are optimized using the design method of the present description;

FIG. 3 illustrates the skin system of FIGS. 1 and 2 showing a target shape for which the skin system is optimized to approximate using the design method of the present description;

FIG. 4 is a functional block diagram of a computer system configured to implement the elastomeric skin design method of the present description;

FIG. 5 is a flow diagram of a skin design method of the present description such as may be provided by operation of the system of FIG. 4; and

FIGS. 6 and 7 illustrate simulations of the movements of an input or unoptimized skin and an output or optimized skin, respectively, for achieving an input artistic target shape during robotics operations.

### DETAILED DESCRIPTION OF THE PREFERRED EMBODIMENTS

Briefly, the following description teaches a computer-assisted method (and a computer system implementing a design tool and skin fabricated according to these designs) for designing elastomeric skin for robots and robotic devices. The skin design tool or program is configured to help with the optimal navigation of the design space spanned by an animatronic or robotic device skin.

The technical core of the skin design tool is provided by a soft body simulator (or simulation process) that is differentiable with respect to control and design parameters. This enables the skin design tool to provide one or more of the following applications: (1) automated identification of an optimal neutral pose for the skin that minimizes peak stresses when the skin is brought into extreme poses such as a smile where stresses are highest at the two mouth corners (e.g., when the skin provides a face or covers a robotic head); (2) automated optimization of the skin thickness and shape of a skin to meet a time-varying artistic target as optimally as possible; and (3) automated optimization of a skin to achieve a desired behavior if the skin is allowed to slide along a rigid shell underneath it.

Examples of design and fabrication of skins or skin systems for covering robotic devices are provided in detail in U.S. Pat. No. 9,403,099, which is incorporated herein in its entirety. In this patent, a computer-based skin design and fabrication system 1200 is shown in FIG. 12, and the skin design tool of the present description may be used within this system 1200 to provide the new skin designs. Hence, aspects of the system 1200 are not described in detail herein but will be readily understood by those skilled in the art as useful for implementing the skin design tool. Likewise, the examples shown herein do not include an entire robotic device or robot or the covering skin for such a robot, but it these can readily be understood from a review of FIGS. 13-20 of this incorporated patent showing a fabricated skin 1640 in FIG. 16 along with robotics 2050 for receiving and actuating the skin 1640.

In this patent, the skin was designed to include integral Elastomeric Actuation Pieces (EAPs), and each of these EAPs were configured with a recessed surface for receiving the tip or head of a rigid EAP mounting post (e.g., formed of metal, a hard plastic, or the like) provided on a driver/actuator of the robotics or provided on an outer surface of a rigid shell encasing the robotics. The EAPs are integral in that they are provided on mounting posts of the mold core and formed of elastomeric materials such that they become bonded to the surrounding skin, e.g., see FIG. 16 of the incorporated patent for a skin 1640 with integrally bonded EAPs such as EAP 1430.

In direct contrast to this teaching, the inventors determined that a different skin design would be useful to minimize stresses within the skin and to facilitate optimization by the skin design tool. The new skin system design includes EAPs, which instead of being provided within the skin are provided on the robotics assembly or robot on a driver/actuator or a surface of a shell. An EAP mounting post is provided as an integral part of the skin (e.g., a post with a tip or head extending outward from an inner surface of the skin) to allow attachment of the skin to the robotics assembly or robot.

Significantly, the EAPs of the new skin system are formed of a material that is stiffer than the body of the skin, and this may be thought of as forming the body of the skin of a layer(s) of material with a first hardness to make it relatively soft and flexible and forming the EAPs of a material with a second hardness, which is significantly greater than the first hardness, such that the EAPs are stiffer. For example, the EAPs may be small, vulcanized rubber or silicone (or silicone rubber) parts with a rectangular or circular cross section body having a recessed surface and have a hardness of 50 to 60 Shore A Durometer or greater. The EAPs may be shaped to receive a ball-shaped tip or head of the EAP mounting post extending outward from the skin (which may also be silicone but of a reduced hardness) or be formed as a groove to allow some movement of the EAP mounting post received therein.

The EAPs are attached, on a first end opposite of the second end containing the recessed surface (or receiving surface), to the mechanical or robotics assembly and to the soft skin via its EAP mounting posts. These two attachments are not rigid, which means that the EAPs can move along the softer skin surface. This non-integral or rigid attachment of the EAP to the skin (as was the case with prior skin designs) can help to significantly reduce stresses.

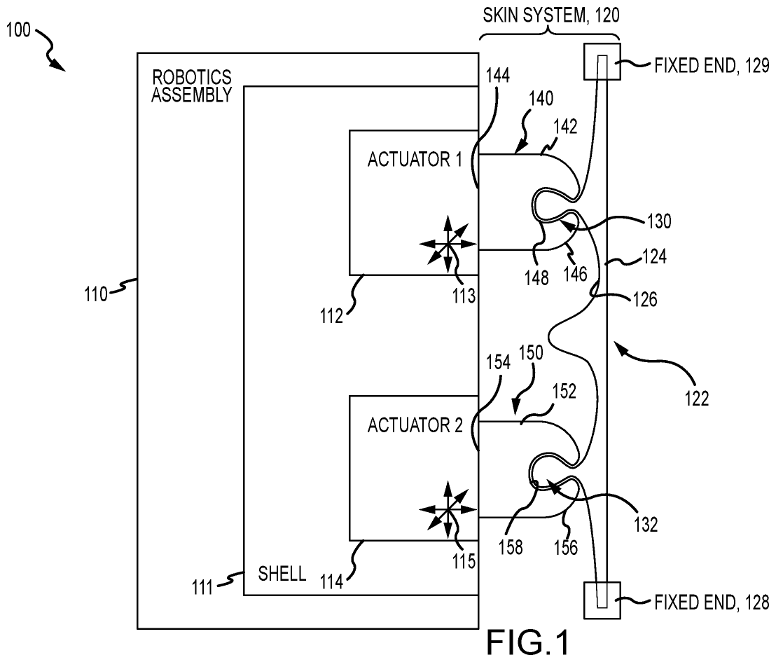

FIG. 1 illustrates, with a schematic or representative side view, a skin-covered apparatus or object 100 with a robotics assembly 110 covered by a skin or skin system 120 designed according to the design method of the present description. The robotics assembly 110 typically will include a shell or support frame 111, and a plurality of drivers or actuators as part of its mechanical assembly used to actuate or move the skin system 120 to simulate a live being such as with facial expressions or the like. In this simplified example, first and second actuators/drivers 112, 114 are provided or positioned within the shell 111 and operate as shown with arrows 113 and 115 to animate portions of the skin system 120.

The skin system 120 includes a skin body or layer(s) 122 with a first or outer surface/side 124 and a second or inner surface/side 126 opposite the first side 124. The body 122 has a thickness and shape that are optimized according to the design methods discussed herein. Extending outward from the second or inner surface 126 of the body 122 are a pair of EAP mounting posts 130 and 132, which are typically formed integrally with the body 122 and of the same relatively soft and flexible material (e.g., a silicone rubber). Each of the mounting posts 130 and 132 has a body ending in a head or tip (which may be generally ball or sphere shaped as shown).

To attach the skin body 122 to the robotics assembly 110, the skin or skin system 120 includes first and second EAPs 140 and 150. As noted above, these are not formed integrally with the skin body 122 and are not bonded to the EAP mounting posts 130 and 132. Instead, they are free to move independently from the EAP mounting posts 130 and 132. As shown, the EAPs 140, 150 each include a body 142, 152 with a substantially rectangular cross-sectional shape. At a first end 144, 154, the EAPs 140, 150 are attached to the actuators/drivers 112, 114 of the robotics assembly 110 (in other cases, one or both may be attached to a surface of the shell 111). At a second end 146, 156, the EAPs 140, 150 include recessed surfaces 148, 158 configured (sized and shaped) to receive the head/tip of the EAP mounting posts 130, 132 so as to attach the skin body 122 to the robotic assembly 110 via the EAPs 140, 150. In some cases, the recessed surfaces 148, 158 may have an opening providing access to a semi-spherical shaped void or space while in other implementations the void or space in which the post heads are received may take the form of an elongated slot or groove with a shape and size suited for the post head/tip (e.g., similar shape and a slightly larger size) to allow the skin body 122 to slide relative to the attachment to the robotics assembly 110 (e.g., over the surface of the shell 111). One or more of the ends 128, 129 are typically attached (to the robotics assembly 110 or another support structure) in a fixed manner.

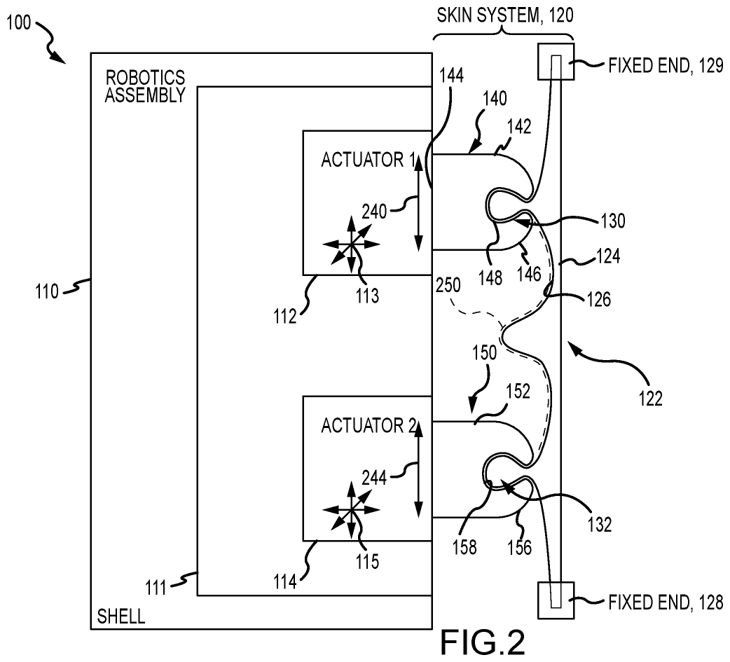

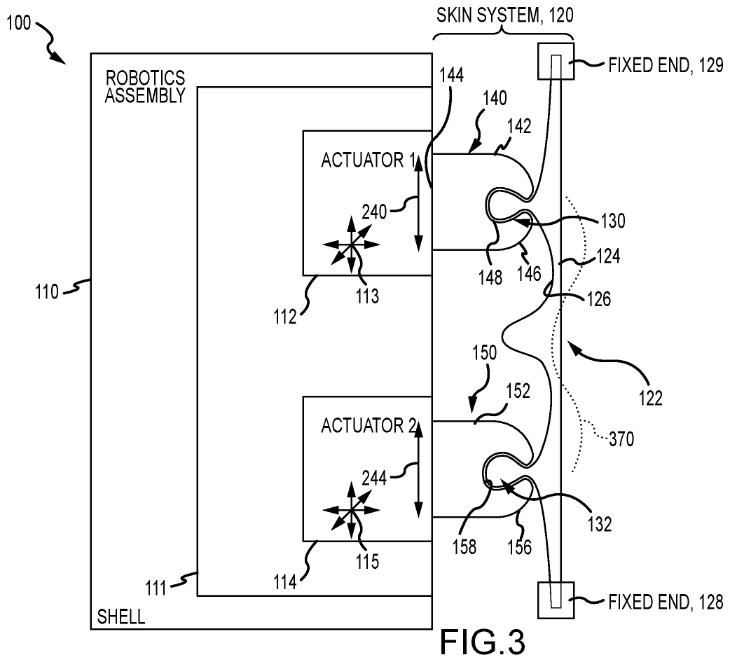

FIG. 2 illustrates the skin-covered apparatus or object 100 of FIG. 1 showing parameters or features of the skin or skin system 120 that are optimized using the design method of the present description. Particularly, in this example, the time-varying positions of the EAPs 112, 114, as represented by arrows 240, 244, are optimized. Further, the shape and thickness of the soft skin body 122 are optimized as indicated by dashed line 250, and it should be noted that both the shape and thickness may vary over the skin body 122 to suit desired artistic targets and to suit expected stresses. As shown in FIG. 3, the EAP movements 240, 244 and the shape and thickness 250 of the skin body 122 are optimized by the design method (as discussed below) such that the target shape 370 input by a user of the design method (or design system) is approximated as closely as possible at a particular time, t (e.g., operating state of the robotics assembly 110).

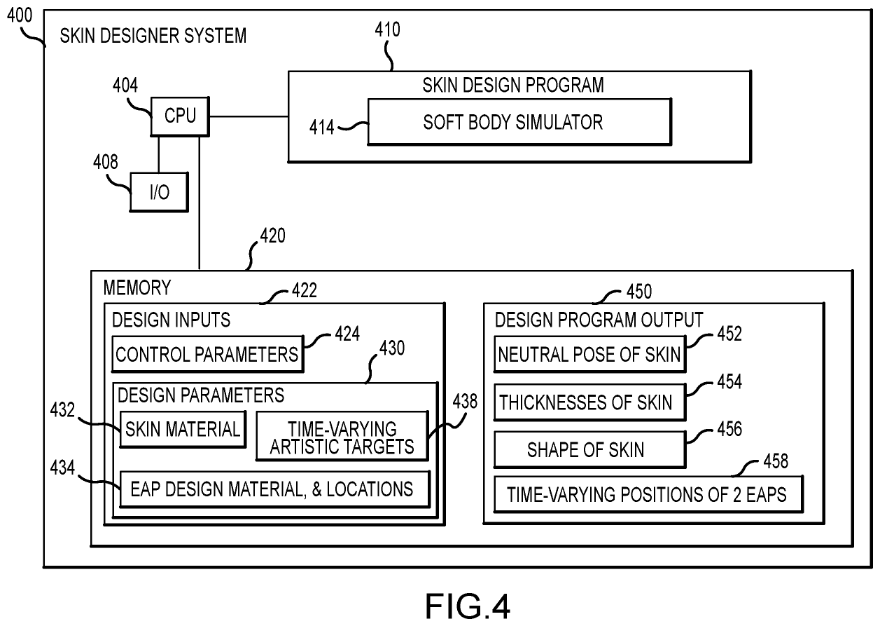

FIG. 4 is a functional block diagram of a computer system 400 configured to provide to implement the elastomeric skin design method of the present description. To this end, the system 400 may take the form of nearly any useful computing device and includes one or more processors 404. The processor(s) 404 is configured to manage operations of memory/data storage 420 and input and output (I/O) devices 408 such as a display, a keyboard, voice activated devices, a touchpad, a mouse, a touchscreen, and the like that allow an operator or user of the system 400 to provide user input. This may include a set of design inputs 422 that the processor 404 stores in memory 420.

The processor(s) 404 are configured to execute code or instructions to run or provide the functionality of a skin design program 410. This program 410 is configured to provide the computational processes to perform the design method taught herein to create a robot skin (such as shown in FIGS. 1-3). As noted above, an important aspect of the program 410 is a soft body simulator 414. The program 410 and/or simulator 414 take as inputs robotic design and control parameters 424 and skin design parameters 430, which may include the material 432 to be used to form the skin being designed as well as EAP parameters 434 such as their body configurations, materials used to form the EAPs, and the locations of the EAPs on the mechanical or robotics assembly. By processing this input to perform simulations and optimizations, the skin design program 410 generates an optimized skin system design or design program output 450. This output 450 may include a neutral pose of the designed skin 452, a thickness of the skin 454, a shape of the skin 456, and time-varying positions of the EAPs 458.

The soft body simulator 414 is specially adapted or written to provide skin body representations that fulfill the following: (1) the simulation handles frictional contact between pairs of soft bodies and between rigid and soft bodies, with this contact model being differentiable; (2) the simulation representation predicts the dynamic behavior of the skin (e.g., the motions of cheeks in a facial skin that move up and down when the simulation is run fast); (3) the simulation representation is differentiable with respect to shape and thickness parameters of the skin body in its unstressed, neutral pose; and (4) the representation is differentiable with respect to the motion of either the EAPs or the control parameters of the motors that are driving the motion of the robotics or mechanical assembly over which the skin body is positioned (via coupling between the EAPs and the EAP mounting posts on the softer skin body).

In one useful implementation, the soft body simulator 414 can be based upon one or more existing differentiable simulators such as PolyFEM developed by New York University. The simulator preferably is configured to provide functionality to run dynamic simulations and take derivatives of the time-varying simulation state with respect to skin shape and thickness parameters of the skin body and also with respect to the time-varying position and orientation of the EAPs.

To measure the distance of the skin surface to a time-varying artistic target, the target can be represented with an implicit representation. In its simplest possible implementation, a regular grid can be initialized with distance values to the surface. Then, these distances can be interpolated in space and time. In the attached figures, a set of examples of the simulation and optimization processes are provided showing what the design method can achieve when implemented by a computer-assistive tool such as system 400 with program 410. For the sake of conciseness, the skin system implemented two EAPs made of a stiffer silicone and a skin patch or body fixed at two ends. The parameters for which optimal adjustments were made are the time-varying positions of the two EAPs and the shape of the silicone skin body in its neutral pose. Frictional contact between the EAPs and the skin body is properly handled as a set of prototype simulations has proven. The artistic target may be time varying, but the examples show a single target for ease of explanation.

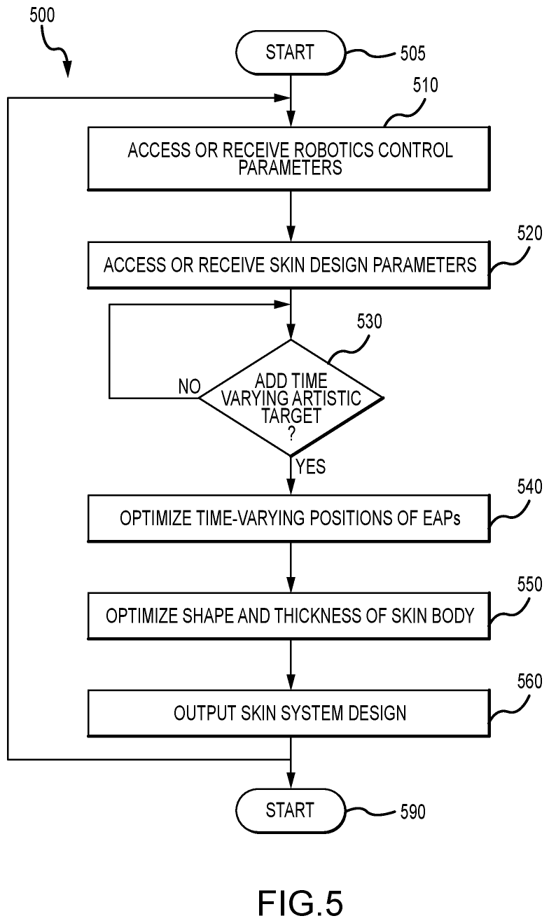

FIG. 5 is a flow diagram of a skin design method 500 of the present description such as may be provided by operation of the system 400 of FIG. 4. The method 500 starts at 505 such as with providing a computer system/device and loading a skin design program with a soft body simulator onto the computer system/device for execution and use by a skin designer. The method 500 continues at 510 with accessing or receiving robotics control parameters, and these may include at least an initial design for a robotic assembly/robot (and in some cases an initial skin or covering design). For example, a robotic head may be provided for animating a character's face, and the drivers/actuators and shell design may be provided for this robotic head in step 510.

In step 520, the method 500 involves accessing or receiving (from memory or from user input via a design GUI generated by the skin design program) skin design parameters to use in optimizing a skin system design. As discussed with reference to the system 400 of FIG. 4, these parameters may include an initial design for a skin system which may include an initial thickness and/or shape and can include locations of EAPs and their configurations along with EAP mounting posts on an inner surface of the skin body. The parameters may also include a material to be used in fabricating the skin and EAPs.

The method 500 continues at 530 with determining whether or not the user has provided a new or additional time-varying artistic target for the skin body (e.g., how does the artist or skin designer wish the skin body to move during robotics operations such as to speak, smile, frown, or the like for a skin system used to simulate a character's face). If not, the method 500 continues at 530 (or 510 and 520). If a target is received, the method 500 continues at 540 with optimization of the time-varying position of the EAPs and then at 550 with optimization of the shape and thickness of the skin body so as to closely approximate the input target shape from step 530 at a time t. The method 500 then continues at 560 with outputting the design for the skin system as defined, in part, by the optimizing of steps 540 and 550, and this design may then be used to fabricate a skin or skin system for use with a particular robotics assembly/robot. The method 500 then can end at 590 or continue with further design steps at 520 for a new skin or at 530 for the same skin system with additional target shapes.

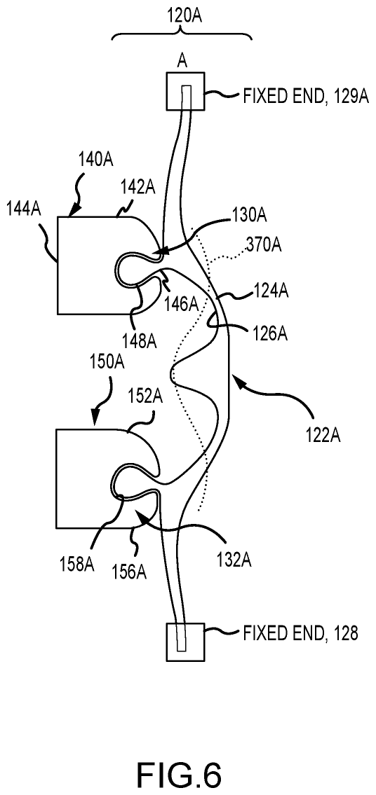

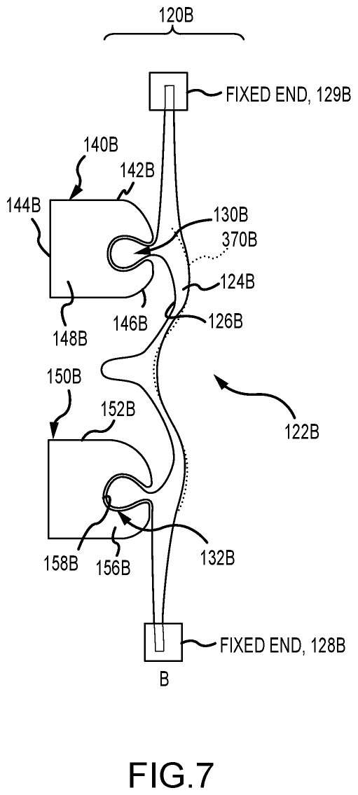

The inventors utilized the optimization methods taught herein for several input target shapes and simulated use of an input/initial or unoptimized skin and an output design or optimized skin during robotics operations to achieve the target at a particular operating time. The results indicated that the new design method was useful in obtaining skins with little or no error in the skin being moved into a shape that closely or nearly exactly matched the target shape while simulation runs with the unoptimized skin showed relatively large errors (or mismatches) between the achieved skin body shape and the target shape In this regard, FIGS. 6 and 7 illustrate simulations of the movements of an input or unoptimized skin 120A and an output or optimized skin 120B, respectively, for achieving an input artistic target shape 370 during robotics operations (e.g., movement of the EAPs by one or more drivers/actuators of the robotics assembly 110).

As shown in FIG. 6, the skin body 122A that had the initial or unoptimized shape and thickness (and initial EAP locations and/or orientations in system/skin 120A) had a relatively large error or mismatch when its shape (or the shape of its outer surface 124A) at a particular operating time is compared with the target shape 370. In contrast, the skin body 122B that had optimized shape and thickness (and had optimized EAP locations and/or orientations in the skin/system 120B) had only a small or no error (or mismatch) when its shape (or the shape of its outer surface 124B) is compared with the target shape 370 at the predefined/selected operating time of the underlying and driving robotics or mechanical assembly.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A system for optimizing design of an elastomeric skin for covering a mechanical assembly, comprising:
a computing device configured to perform the following:
receiving or accessing in memory user input including a definition of the mechanical assembly design and control parameters for the mechanical assembly;
receiving or accessing in memory a set of design parameters for a skin, for at least partially covering the mechanical assembly, including material used to fabricate a body of the skin, an initial shape of the body of the skin, and an initial thickness of the body of the skin; and
receiving or accessing in memory a target shape of an outer surface of the body of the skin at a predefined time of operations of the mechanical assembly; and
a skin design program, running on the computing device, generating an optimized design for the skin by generating an optimized shape of the body and an optimized thickness of the body based on the initial shape and the initial thickness, wherein the optimized shape and the optimized thickness are selected such that the outer surface of the body of the skin substantially matches the target shape at the predefined time during the operations of the mechanical assembly.

2. The system of claim 1, wherein the user input further comprises a definition of a set of Elastomeric Actuation Pieces (EAPs) for attaching the skin body to the mechanical assembly, wherein the definition includes a definition of body shapes and materials for the EAPs along with a location for mounting each of the EAPs on the mechanical assembly, and wherein the EAPs are attached on a first side to the mechanical assembly and have a second side with a recessed surface for receiving a portion of an EAP post extending outward from an inner surface of the skin body, whereby the EAPs are not integrally bound to the skin body.

3. The system of claim 2, wherein the EAPs are formed of a material with a hardness greater than a hardness of the material used to form the body of the skin.

4. The system of claim 2, wherein the generating of the optimized design further comprises optimizing time-varying positions of one or more of the EAPs.

5. The system of claim 1, wherein the generating of the optimized design further comprises generating a neutral pose for the skin body.

6. The system of claim 1, wherein the skin design program comprises a soft body simulator configured to simulate movement of the body of the skin during operations of the mechanical assembly.

7. The system of claim 6, wherein the soft body simulator is configured to process frictional contact between soft bodies and between rigid and soft bodies via a contact model that is differentiable.

8. The system of claim 6, wherein the soft body simulator is configured to predict dynamic behavior of the skin system during operations of the mechanical assembly.

9. The system of claim 6, wherein the soft body simulator is configured to be differentiable with respect to the shape and the thickness of the body of the skin in an unstressed, neutral pose.

10. The system of claim 6, wherein the soft body simulator is configured to be differentiable with respect to motion of either the EAPs or the control parameters of motors of the mechanical assembly operable to drive motion of the mechanical assembly.

11. A robot fabricated to include a physical implementation of the mechanical assembly covered by a skin fabricated based on the definition of the optimized design for the skin system of claim 1.

12. A method for optimizing design of an elastomeric skin for covering a mechanical assembly, comprising:
with a computing device, receiving or accessing in memory a set of design parameters for a skin system for covering at least a portion of the mechanical assembly;
with the computing device, receiving or accessing in memory a target shape of an outer surface of a body of the skin system at a predefined time of operations of the mechanical assembly;
with a skin design program running on the computing device, generating an optimized design for the skin system by generating an optimized shape of the body and an optimized thickness of the body,
wherein the optimized shape and the optimized thickness are selected such that the outer surface of the body substantially matches the target shape at the predefined time during the operations of the mechanical assembly,
wherein the user input further comprises a definition of a set of elastomeric actuation pieces (EAPs) for attaching the body to the mechanical assembly,
wherein the definition includes a definition of body shapes and materials for the EAPs along with a location for mounting each of the EAPs on the mechanical assembly, and
wherein the EAPs are attached on a first side to the mechanical assembly and have a second side with a recessed surface for receiving a portion of an EAP post extending outward from an inner surface of the body, whereby the EAPs are not integrally bound to the body.

13. The method of claim 12, wherein the EAPs are formed of a material with a hardness greater than a hardness of the material used to form the body.

14. The method of claim 12, wherein the generating of the optimized design further comprises optimizing time-varying positions of one or more of the EAPs.

15. The method of claim 12, wherein the generating of the optimized design further comprises generating a neutral pose for the skin body and wherein the skin design program comprises a soft body simulator configured to simulate movement of the body of the skin during operations of the mechanical assembly.

16. The method of claim 15, wherein the soft body simulator is configured to process frictional contact between soft bodies and between rigid and soft bodies via a contact model that is differentiable, wherein the soft body simulator is configured to predict dynamic behavior of the skin system during operations of the mechanical assembly, wherein the soft body simulator is configured to be differentiable with respect to the shape and the thickness of the body of the skin in an unstressed, neutral pose, and wherein the soft body simulator is configured to be differentiable with respect to motion of either the EAPs or the control parameters of motors of the mechanical assembly operable to drive motion of the mechanical assembly.

17. A computer system for optimizing design of an elastomeric skin for covering a mechanical assembly, comprising:
memory storing user input including a definition of the mechanical assembly design and control parameters for the mechanical assembly, wherein the memory further stores a set of design parameters for a skin, for at least partially covering the mechanical assembly, including material used to fabricate a body of the skin, an initial shape of the body of the skin, and an initial thickness of the body of the skin;
a graphical user interface (GUI) displayed on a monitor and configured for receiving user input including a target shape of an outer surface of the body of the skin at a predefined time of operations of the mechanical assembly;
a skin design program provided by a processor executing code, wherein the skin design program is configured for generating an optimized design for the skin by generating an optimized shape of the body and an optimized thickness of the body based on the initial shape and the initial thickness and wherein the optimized shape and the optimized thickness are selected such that the outer surface of the body of the skin substantially matches the target shape at the predefined time during the operations of the mechanical assembly.

18. The system of claim 17, wherein the user input further comprises a definition of a set of Elastomeric Actuation Pieces (EAPs) for attaching the skin body to the mechanical assembly, wherein the definition includes a definition of body shapes and materials for the EAPs along with a location for mounting each of the EAPs on the mechanical assembly, and wherein the EAPs are attached on a first side to the mechanical assembly and have a second side with a recessed surface for receiving a portion of an EAP post extending outward from an inner surface of the skin body, whereby the EAPs are not integrally bound to the skin body.

19. The system of claim 18, wherein the generating of the optimized design further comprises optimizing time-varying positions of one or more of the EAPs.

20. The system of claim 17, wherein the skin design program comprises a soft body simulator configured to simulate movement of the body of the skin during operations of the mechanical assembly and wherein the soft body simulator is configured for at least one of the following: processing frictional contact between soft bodies and between rigid and soft bodies via a contact model that is differentiable; predicting dynamic behavior of the skin system during operations of the mechanical assembly; differentiating with respect to the shape and the thickness of the body of the skin in an unstressed, neutral pose; and differentiating with respect to motion of either the EAPs or the control parameters of motors of the mechanical assembly operable to drive motion of the mechanical assembly.
